(19) United States
(12) Patent Application Publication
(10) Pub. No.: US 2009/0303520 A1
(43) Pub. Date: Dec. 10, 2009

(54) PARTS IN A PRINT JOB REFERENCED BY MULTIPLE PARENTS

(76) Inventor: Uri Vered, Petach-Tikva (IL)

Correspondence Address: AMELIA A. BUHARIN, PATENT LEGAL STAFF;EASTMAN KODAK COMPANY, 343 STATE STREET, ROCHESTER, NY, 14650-2720, US

(21) Appl. No.: 12/132,675

(22) Filed: Jun. 4, 2008

(51) Int. Cl. G06F 3/12

(52) U.S. Cl. 358/1.15

(57) ABSTRACT

A method for sharing printing elements (33, 34) between plurality of printing product job versions including providing plurality of printing job versions (31A, 31B, 31C, 31D) structures which all are part a single printing job (30). The printing elements (33, 34) which are shared between different printing job versions are identified and are referenced back into the different printing job versions, and printing elements to at least two printing job versions. Any change in the properties of a printing job version such as quantity or the imposition scheme will be automatically reflected in the printing elements referenced (51) by the printing job versions.

### CROSS REFERENCE TO RELATED APPLICATIONS

Reference is made to commonly-assigned copending U.S. patent application Ser. No. 12/029,485, filed Feb. 12, 2008, entitled A PRINTING PRODUCTION PLAN GENERATION SYSTEM, by Vered, the disclosure of which is incorporated herein.

### FIELD OF THE INVENTION

This invention relates to creation of print manufacturing plans and more specifically to methods of handling shared printing job parts which are referenced by multiple parents.

### BACKGROUND OF THE INVENTION

Printing manufacturing and production systems provide hierarchal tree structures to describe printing jobs. FIG. 1 depicts a table describing a basic print job 10 structure and FIG. 2 describes the parts list tree constituent of a basic print job 10.

Basic print job 10 comprises the following printing elements:
a) Parent parts 11, typically describing the general content of a basic print job 10.
b) Cover child part 13, describing the printing elements relevant to the printing the cover.
c) Child parts 12, describing printing elements such as inner text sections of a basic print job 10.

In the case of basic print job 10 all the parts (11, 12, 13) which form basic print job 10 are used for printing of a single version of print job 10. The parts (11, 12, 13) are not shared between similar printing versions. This requirement simplifies basic print job 10 production in comparison to a print job where at least one part in the print job is used in more than one printing instance.

FIG. 3 describes a typical complex print job 30, in the form of a table. Complex print job 30 is more complex than basic print job 10. For example purposes, complex print job 30 will be 45,000 printed copies encompassing four different book versions. The complex print job 30 comprises four books (Book A, B, C, and D). Each of the four books comprises a set of child parts 32A for book A, 32B for book B, 32C for book C, and 32D for book D. Each book represents a different version, each version includes parts specific to a book version called parent parts 11. Some of the child parts 12 comprised in complex print job 30 might be shared between different book versions.

All parent parts 11 have one or more child parts 12 associated with them and are assembled with them. All the child parts 12 have only one parent part 11. Often child parts 12 are shared between parent parts 11. An example of such shared parts is the shared cover parts 33 and shared text parts 34. The relation to the common parts is presently handled by a manual means, that is the person responsible for manufacturing of complex print job 30 makes sure that there is a satisfactory quantity of shared parts for consumption by all the different book versions of complex print job 30. There is no automatic support for handling parts lists which are shared between different versions of the same print job.

The printing manufacturing and production systems available today do not support parts hierarchy which is dependent upon multiple parents or multiple versions of a print job. Introduction of changes into the manufacturing plans of such systems are cumbersome due to the manual work that is required and as such is error prone.

For example, an increase to the number of book version B represented by parent part 31B may be required. Such a change will yield an increased number of book B child parts 32B. The book B child parts 32B comprises a cover part 33 which is shared between book A and book B, a book B specific text part 35 and a shared text part 34 (shared between all book versions, A, B, C, and D). In the systems available today, all changes of parent parts 11 and child parts 12 that stem from the described change in the manufacturing plan must be entered manually into the system.

For better understanding a reference is made to FIG. 4. FIG. 4 depicts a hierarchal tree representation of the various parts (11 and 12) indicated by parts tree structure 41 representing the content of complex print job 30. Shared parts 33 and 34 are linked to one of the complex print job 30 book versions, in this example, book A is represented by parent part 31A. A quantity increase of book B child part 32B from 25,000 to 30,000 will have an impact on book B parent part 31B and book B child parts 32B. The book specific text part 35 will be automatically updated, however, shared cover part 33 and shared text part 34 should be updated as well. Since shared cover part 33 and shared text part 34 are linked to parent part 31A (representing book A), the above quantity increase in book B will not affect shared cover part 33 and shared text part 34 in an automatic manner, therefore a manual update is performed reflecting the cost change in the labor and material aspects.

The manual changes might include at least the following:
1. Configuring the child parts manufacturing quantities according to all related parent parts. For example, if the sum of all parents that are related to a child part is 100,000, then the quantity of the child part needs to be changed to 100,000.
2. Configuring all the finishing operations (e.g. binding, packaging, and shipping) that need to be changed according to all shared (common) child part. For example, a packaging operation needs to be configured manually in order to take into account shared parts that are not configured directly under a finishing parent part.
3. All waste quantities that occur in all parent parts that are not directly related to the child parts need to be manually calculated in order to alter the quantity of the child common part.

Every time that there is a change in the configuration of shared printing part the user must remember to update all the related finishing parts, a process which tends to be error prone.

### SUMMARY OF THE INVENTION

Briefly, according to one aspect of the present invention a method for sharing printing elements between pluralities of printing job versions includes providing plurality of printing job versions structures which are part of a single printing job; identifying the printing elements which are used by more than one printing job version and referencing those printing elements to the respective printing job versions; and updating automatically the change in properties of a printing version to be properly reflected in the printing elements referenced by the printing job versions.

These and other objects, features, and advantages of the present invention will become apparent to those skilled in the art upon a reading of the following detailed description when taken in conjunction with the drawings wherein there is shown and described an illustrative embodiment of the invention.

### BRIEF DESCRIPTION OF THE DRAWINGS

FIG. 1 is a table describing printed parts comprising a basic printing job;

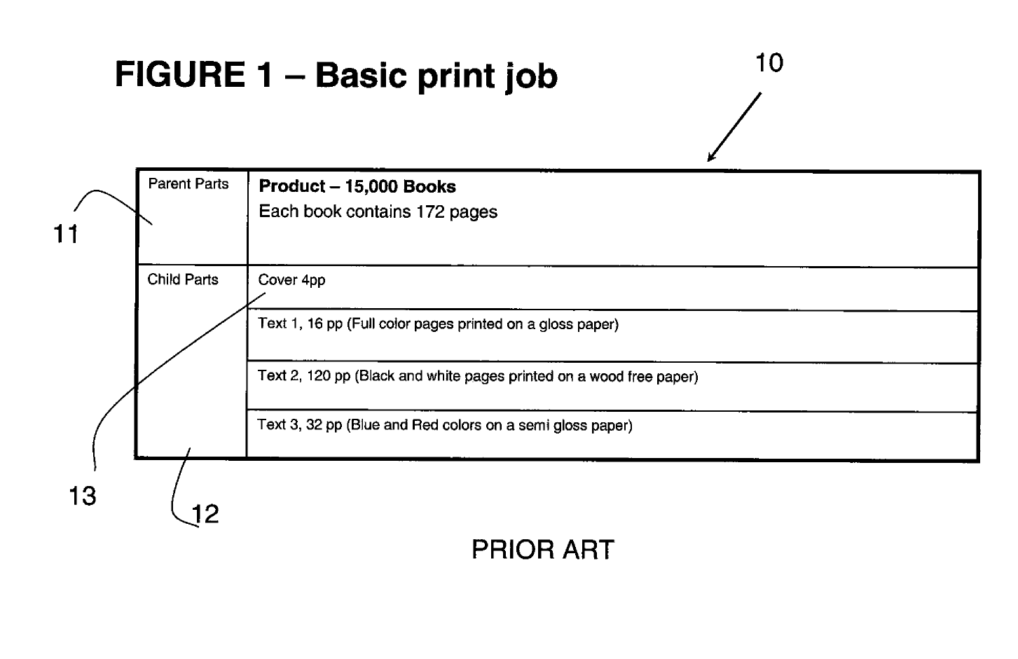

FIG. 2 is a schematic describing a printed parts structure for a basic printing job;

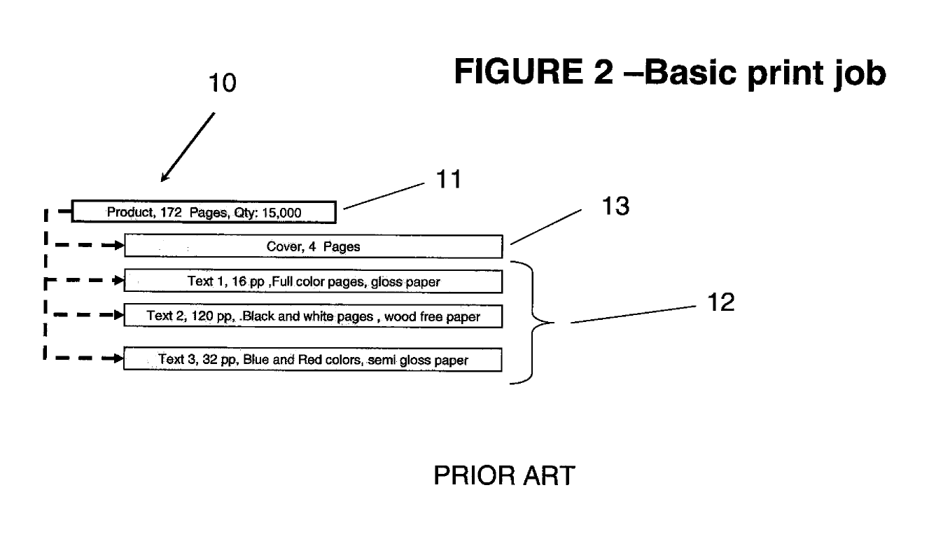

FIG. 3 is a table describing printed parts wherein some parts are shared between different versions of a printing job;

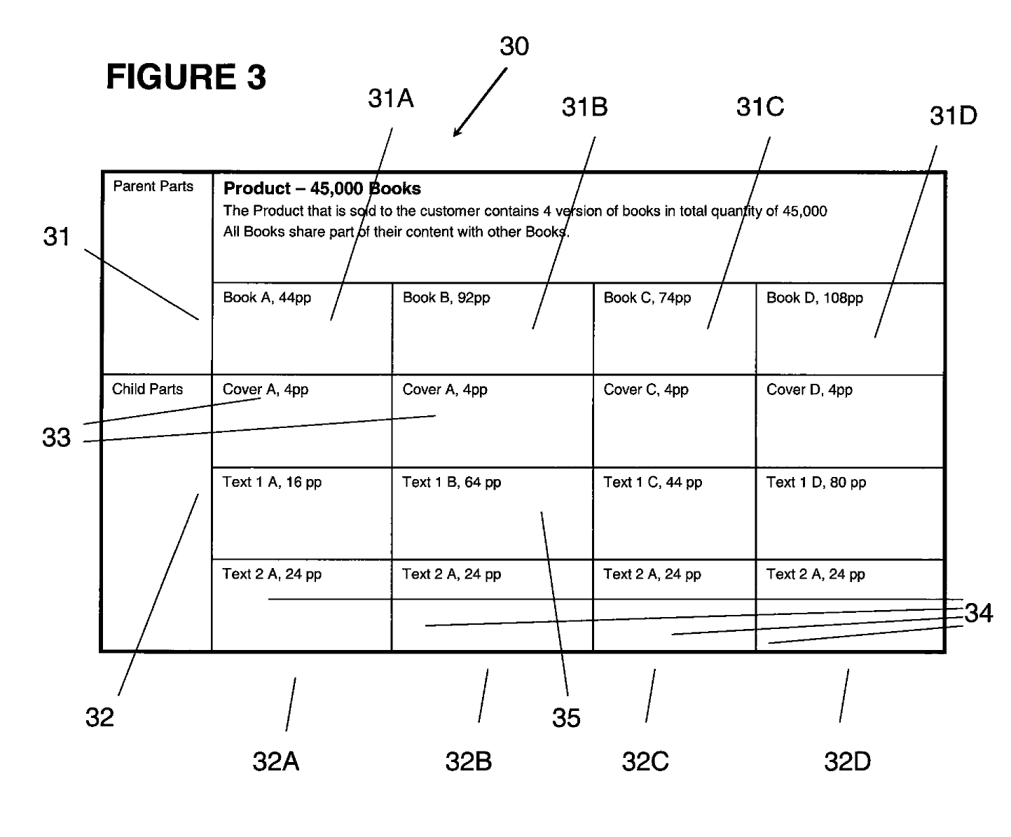

FIG. 4 is a schematic describing printed parts structure and the inter relations between shared parts within different versions of a printing job as are used today; and

FIG. 5 is a schematic describing printed parts structure and the interrelation between shared parts within different versions of a printing job as is disclosed in the present invention.

### DETAILED DESCRIPTION OF THE INVENTION

Complex print job 30 includes a group of printing products, each consisting of book specific content parts 35 and shared text parts 34. Good product price estimation while maintaining profitability can be achieved by manufacturing of all products in the most efficient way with minimal waste of material and labor costs.

This goal can be reached when the planning of the exact quantities comprising the various parts of the complex print job 30 is conducted efficiently. The book specific parts 35 as well as shared text parts 34 should be considered. Complex print job 30 should preferably be executed in a single manufacturing instance. It is common to print different versions of booklets and brochures in one job yielding considerable saving on setup time and material waste such as paper and printing plates.

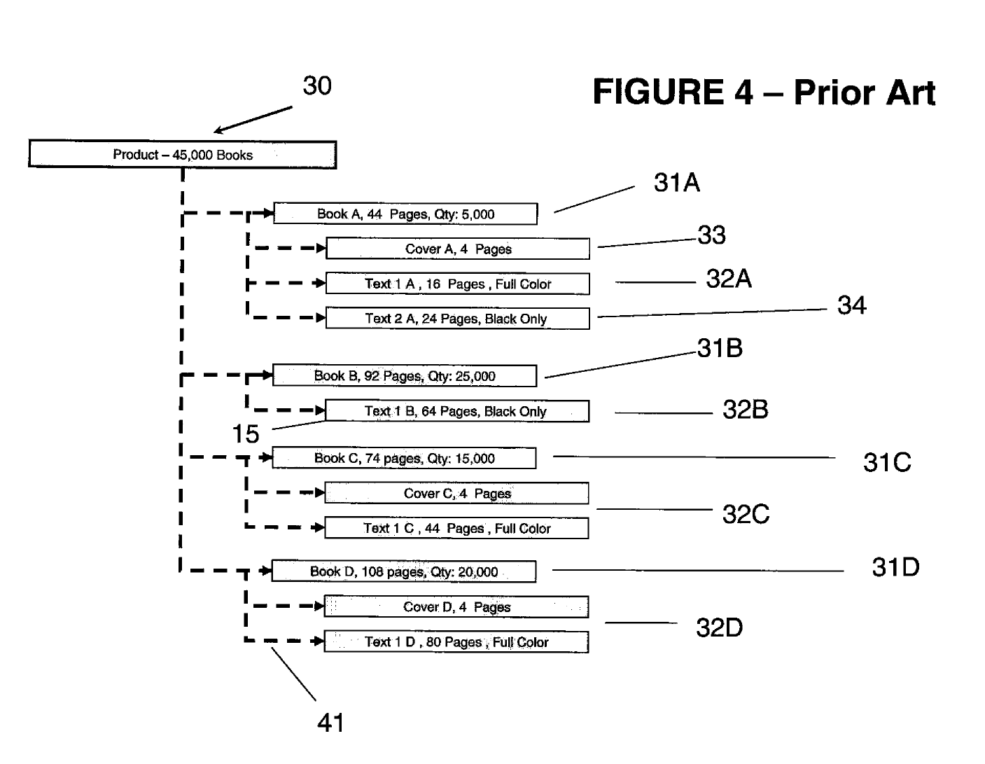

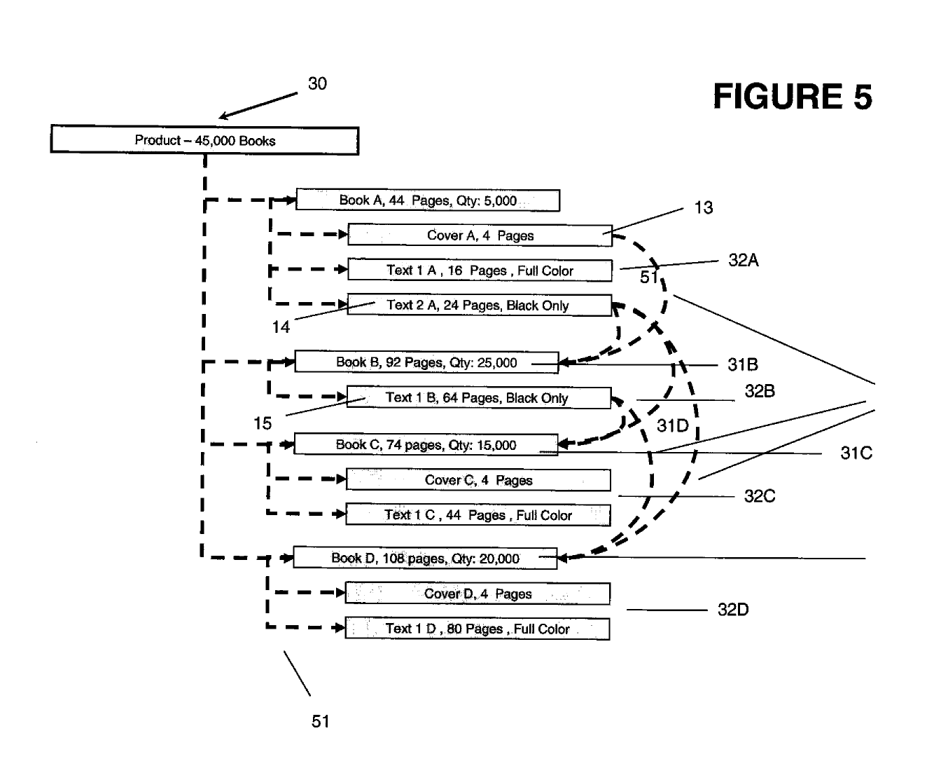

FIG. 5 describes a hierarchical tree similar to the one described in FIG. 4. The difference is the introduction of multiple parent relation links 51. The multiple parent relation enables parent parts 11 to share parts (as shared text part 34) between different versions of the complex print job 30. For example, shared cover child part 33 is linked to book A parent part 31A and is shared with book B parent part 31B. Book B parent part 31B has a link to shared cover child part 33 as well. Another example shows a shared text child part 34 linked to parent parts 31A, 31B, 31C, and 31D. The multiple parent relationship is indicated by multiple parent relation links 51.

The incorporation of multiple parent relation links 51 in the complex print job 30 scheme provides considerable changes in the manufacturing plan. The multiple parent relation links 51 provides robust and up-to-date product price and cost information. All changes made in the configuration of labor and materials for example will be automatically updated in the plan of complex print job 30.

The automatic changes might include:
1. Configuring correct child parts 12 manufacturing quantities complying with the requirements of the related parent parts 11.
2. Configuring all the finishing operations (e.g. binding, packaging, and shipping) that need to be updated by considering shared child parts (33, 34) and their relations with the updated information of the parent parts 11. This information will be automatically updated.
3. The shared child parts (33, 34) quantities are set automatically to correctly reflect parent parts 11 requirements, thus minimizing production waste and preventing lack of sufficient part quantity needed for smooth manufacturing of complex print job 30.

To better illustrate the need for multiple parents support in the printing plan manufacturing systems few examples are described. One example is from catalog printing. In catalog production plurality of slightly different versions are often required. This is needed to efficiently address different groups of customers which are interested in a combination of catalog portions. A portion of shared or common products and another portion that represents products targeted to a specific market segment. Such specific segments usually represent a catalog portion targeted towards a specific region, or that is targeted to a specific gender or age group. In this scenario there is a need to print common parts in quantities that are the sum of the common parts referenced by all the different versions of the print job.

Another example relates to multiple versions of booklet production. This embodiment has similar content which requires different type of finishing due to different quantities needed per different version. In this scenario, the content is the same but the binding is different, for example prefect bound versus saddle stitch will have an impact on the size of the booklet cover. In this example the two versions will differ in the cover characteristics, however, the inner content of the two versions will stay the same.

The invention has been described in detail with particular reference to certain preferred embodiments thereof, but it will be understood that variations and modifications can be effected within the scope of the invention.

### PARTS LIST

10 basic print job
11 parent parts
12 child parts
13 cover
30 complex print job
31A book A parent part
31B book B parent part
31C book C parent part
31D book D parent part
32A book A child part
32B book B child part
32C book C child part
32D book D child part
33 shared cover part
34 shared text part
35 book specific part
41 parts tree structure
51 multiple parent relation links

1. A method for sharing printing elements between a plurality of printing job versions comprising the steps of:
a) providing a plurality of printing job versions structures wherein said plurality of printing job versions are part of a single printing job;
b) identifying said printing elements which are used in at least two of said printing job versions; and
c) referencing said identified printing elements to said at least two printing job versions.

2. A method according to claim 1 wherein a change in properties of a printing version will be automatically reflected in said printing elements referenced by the said at least two printing job versions.

3. A method according to claim 1 wherein a change in said printing elements referenced by the said at least two printing will be automatically reflected in properties of a printing version.

4. A method according to claim 2 wherein said change in properties is a change in quantity.

5. A method according to claim 2 wherein said change in properties is an imposition scheme change.

6. A method according to claim 4 wherein said change of quantity causes a change in quantity of said printing elements.

7. A method according to claim 5 wherein said imposition scheme change causes a change in the cover part of said printing job version.

8. A method according to claim 5 wherein said imposition scheme change causes a change in at least one of said printing elements in said printing job version.
